(19) United States
(12) Patent Application Publication
(10) Pub. No.: US 2007/0181613 A1
(43) Pub. Date: Aug. 9, 2007

(54) Powder dispenser

(76) Inventors: Tal Eldar Ben-Shlomo, Ramat-Hasharon (IL); Itamar Burstein, Tel Aviv (IL)

Correspondence Address: Pearl Cohen Zedek Latzer, LLP, Suite 1001, 10 Rockefeller Plaza, New York, NY, 10020, US

(21) Appl. No.: 11/350,142

(22) Filed: Feb. 9, 2006

(51) Int. Cl. G01F 11/20

(52) U.S. Cl. 222/413

(57) ABSTRACT

A dispensing device for conveying powders or other flowing materials such as, for example, sugar, flour, oats, or rice is provided. The device may include a stand holding a tube or other conveyor and a connection unit which may be connected to a container. The tube may include a handle and a screw conveyor and the flowing materials may flow through the tube to be dispensed.

### FIELD OF THE INVENTION

The present invention relates to devices for dispensing and conveying powders or other flowing materials such as, for example, sugar, flour, oats, rice and the like; other powders or substances may be held.

### BACKGROUND OF THE INVENTION

Devices for dispensing and conveying powders or other flowing materials such as, for example, sugar, flour, oats, rice and the like are known. However, there is a need for a device efficiently and easily dispensing such materials, and having simple operation, and for example for holding materials to be dispensed hygienically.

### SUMMARY OF THE INVENTION

In one embodiment of the present invention, a device is provided for dispensing and conveying powders or other flowing materials such as, for example, sugar, flour, oats, or rice. The device may include a stand holding a tube or other conveyor and a connection unit which may be connected to a container. The tube may include a handle and a screw conveyor and the flowing materials may flow from the container, through the tube and for example into a container.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 depicts a powder dispensing device, according to one embodiment of the present invention;

FIG. 2 depicts elements of a powder dispensing device, according to one embodiment of the present invention;

FIG. 3 depicts a container of a powder dispensing device, according to one embodiment of the present invention;

FIGS. 4a, 4b, and 4c depict powder flow inside a funnel element and a tube of a powder dispensing device, according to one embodiment of the present invention; and

FIG. 5 depicts a rotating cap and a seal element of a powder dispensing device, according to one embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the invention will be described. For purposes of explanation, specific configurations and details are set forth in order to provide a thorough understanding of the invention. However, it will also be apparent to one skilled in the art that the invention may be practiced without the specific details presented herein. Furthermore, well known features may be omitted or simplified in order not to obscure the invention.

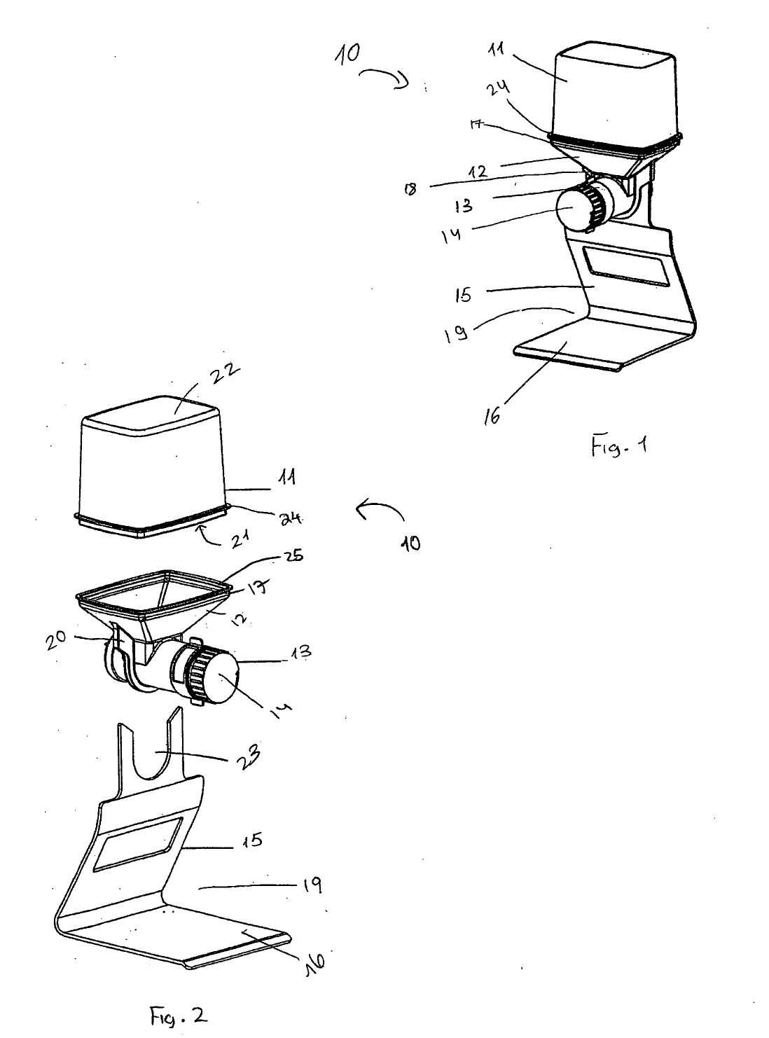

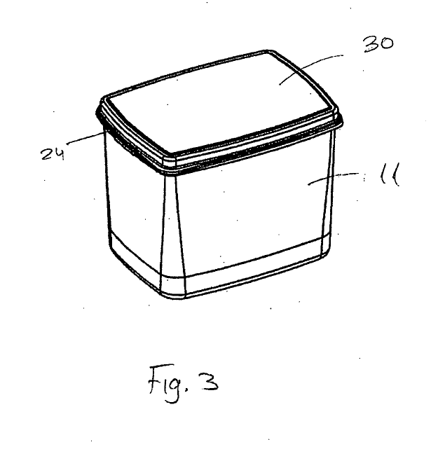

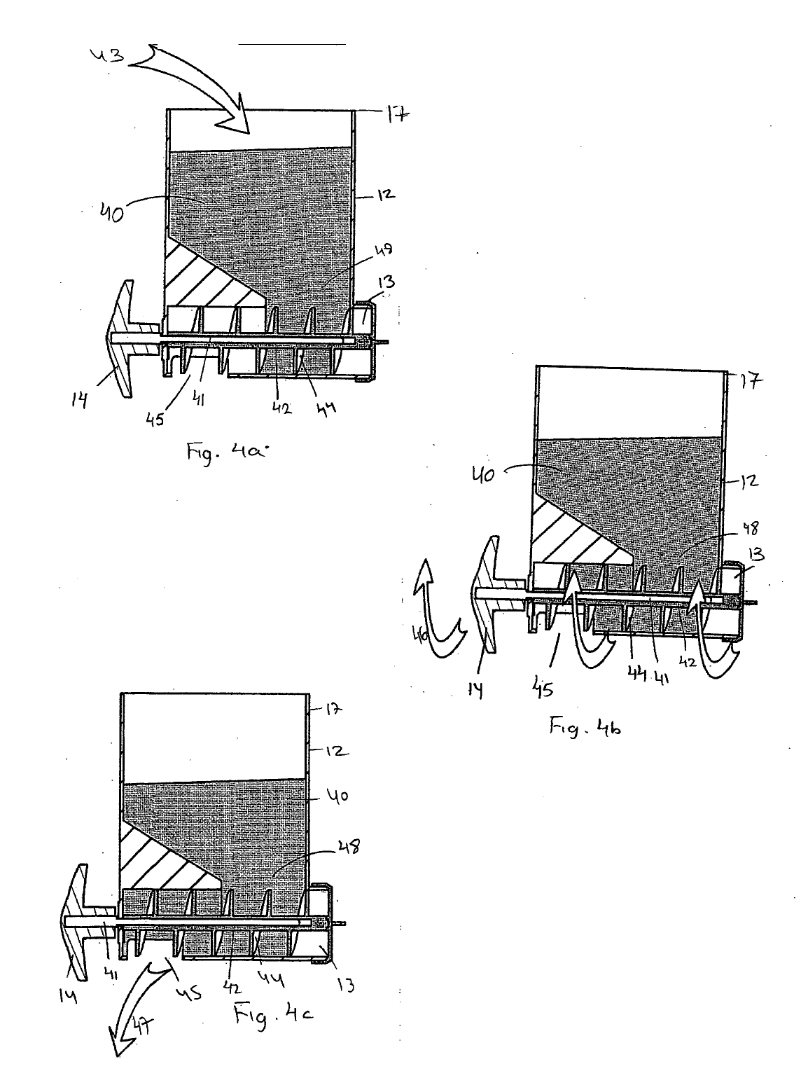

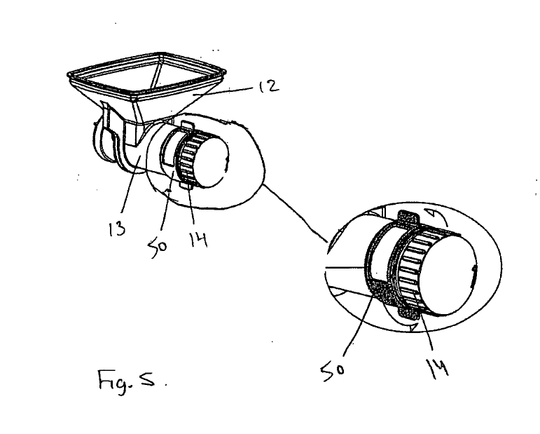

FIG. 1 depicts a powder dispensing device, according to one embodiment of the present invention. Referring to FIG. 1 device 10 may include a removable container or receptacle 11 which may be used for holding and dispensing flowing materials such as sugar, flour, oats, rice and the like. Powders or materials other than flowing materials may be held. Device 10 may include a funnel element or cone-shaped element 12 which may include a wide end 17 and a narrow end 18. Other structures or shapes for elements connecting a container to a conveyor tube may be used; in some embodiments no such intermediate structure is used. Funnel element 12 may be connected or attached to container 11 at its wide end and to a tube or cylinder 13 at its narrow end. Funnel 12 may be used for conveying or delivering the contents of container 11 into tube 13. Tube or cylinder 13 may include a handle or knob 14 connected at one end of tube 13 to an inner screw conveyor 42 as for example shown in FIGS. 4a, 4b and 4c. Handle 14 may be rotated or swiveled in order to allow rotation of inner screw conveyor 42 and conveying of the contents of container 11 into an outside container, bowl or the like (not shown). Tube 13 may be connected to stand or holding element 15 which may include a flat base 16 to enable positioning of device 10 on a flat plane or flat surface and may allow a bowl or a container to be placed in the open space or area 19 below tube 13 and above base 16 in order to collect the dispensed material.

FIG. 2 depicts elements of a powder dispensing device, according to one embodiment of the present invention. Referring to FIG. 2 device 10 may include removable container 11, funnel element 12, tube 13 and holding element 15. Device 10 may be used for holding and dispensing powders or flowing materials such as sugar, flour, oats, rice and the like. In some embodiments funnel element 12 and tube 13 may be formed as one element while in other embodiments, element 12 and tube 13 may be separate but connected. For example, device 10 may include joint member 20 which may hold funnel element 12 and tube 13 together, and which may be removed in order to separate funnel element 12 from tube 13 when needed. Container 11 may hold the material and may be connected or attached to funnel element 12 by a sealable connection 24 and a sealable connection 25, e.g., similar to the connection between plastic containers and plastic covers. The connection between sealable connection 24 and sealable connection 25 may be a sealable connection, such as a plastic sealable connection used in Tupperware™ sealable containers, such that when opening 21 is sealed to funnel element 12, an airtight seal is formed at connection 24. In some embodiments container 11 may be fixed to or integral with funnel 12. Any other suitable connection or attachment means may be used. In order to connect container 11 and funnel element 12 a user may remove or disconnect funnel element 12 or funnel element 12 together with tube 13 from holding element 15 and may connect the wide end or opening 17 of funnel element 12 to the opening 21 of container 11. The connection may be performed while container 11 is in a standing position, e.g., container base 22 is positioned on a flat surface like a table, a kitchen work surface or any other plane surface. Holding element 15 may include an open space 23 which may fit the size and shape of joint member 20 or tube 13 and may keep tube 13 attached or connected to holding element 15. The contents of container 11 may flow, be conveyed or be transferred from container 11 through tube 13 and into a bowl or other container (not shown) by turning or rotating handle or knob 14. Rotation of handle 14 may lead to a circular movement of an inner screw conveyor 42 which may be disposed within tube 13 (an example of which shown in FIGS. 4a, 4b and 4c) and to flowing or conveying the contents of container 11 outside tube 13.

FIG. 3 depicts a container of a powder dispensing device, according to one embodiment of the present invention. Referring to FIG. 3 sealable container 11, such as or similar to a Tupperware™ sealable container, may be made of plastic, glass or any other material. Sealable container 11 may have a top, lid or cover 30 which may have the same perimeter or circumference as connection 24 and funnel element wide end 17 shown in FIG. 1 to help ensure a matching of container 11 and funnel element 12 also shown in FIG. 1. Sealable container 11 may have different volumes and sizes. Container 11 may have other shapes, such as a cylinder, an oval or any other shape, may not be sealable, and may not be removable. The circumference of the upper portion or connection 24 of container 11 (shown in FIG. 2) may match the circumference of connection 25 of funnel element 12 (shown in FIG. 2). A user may have plurality of containers such as container 11 each of which may fit funnel 12 and may hold a different kind of flowing material or powder in each container. A user may choose a required content, remove cover 30 of container 11 and connect funnel 12 to container 11 in order to dispense the contents into a bowl or container.

FIGS. 4a, 4b, and 4c depict powder flow inside a funnel element and a tube of a powder dispensing device, according to one embodiment of the present invention. Referring to FIG. 4a tube 13 which may be connected to funnel element, receptacle or connection unit 12 may include an inner screw conveyor 42. Screw conveyor 42 may be a conventional screw conveyor, for example having a threading or screw surrounding an axis, and may when turned draw material horizontally, along the axis, by for example the force of screw blades. Container 11 may be removably attached to the receptacle or funnel 12. Tube 13 may include an opening 45 on the bottom of the tube to dispense material and an opening 48 on the top of the tube to accept material. Connection unit or funnel element 12 may extend from opening 48. In some embodiments of the invention opening 45 may be closer to handle 14 than opening 48 which may be located beneath funnel 12. Inner screw conveyor 42 may include a pivot, axle or hinge 41 which may be fixed to or integral with handle 14 and may be placed along, fixed to or integral with screw blade elements 44. When container 11 is attached or connected to funnel element upper side 17 the contents or flowing material 40 of container 11 may flow down as shown in arrow 43. Handle 14 may be rotated or turned up as shown in FIG. 4b arrow 46 in order to draw flowing material 40 along screw blade elements 44, to fill tube 13 volume as shown in FIG. 4b, and to dispense out of opening 45 as is shown in FIG. 4c arrow 47. Opening 45 may be located at the bottom of tube 13. Any other location of opening 45 along tube 13 may be used. Any size of opening 45 may be used. Open space 19 (shown in FIGS. 1 and 2) may be located between opening 45 and base 16. A bowl, cup or other receptacle may be placed in space 19 to receive material. Base 16 in combination with other portions of stand or holding element 15, tube 13, or other elements define open space 19. Base 16 may have other configurations, such as two or more spread feet or legs (e.g., formed from bars or formed from a sheet having material cut away, or by molded plastic or metal) with an open space between them, a circular element, etc. Defining open space 19 may allow the opening 45 to be raised to a convenient height above a countertop or table, and allow a user to insert containers of varying size to receive material dispensed from device 10.

FIG. 5 depicts a rotating cap and a sealing element of a powder dispensing device, according to one embodiment of the invention. Referring to FIG. 5 tube or cylinder 13 may include a handle or rotating cap 14 and a rotating seal element 50. Handle 14 may be fixed to or integral with tube 13. In some embodiments handle 14 may be connected to tube 13 by, for example, a screwing mechanism, snap or other method in order to allow disconnection of the elements for, for example, cleaning and drying purposes. Sealing element 50 may be fixed to or attached to tube 13 at the connection point of tube 13 and handle 14. Sealing element may keep the contents of tube 13 and funnel element 12 fresh and may prevent any humidity and contamination from getting into the content.

In some embodiments, while material is in the dispensing device, it may be substantially sealed within the device, and if removable containers are used, the containers themselves may be used to separately store materials or powders in a sealed manner.

It should be noted that although a portion of the discussion may relate to holding and dispensing of powder, the present invention is not limited in this regard, and embodiments of the present invention may be used to hold and dispense other suitable materials.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

1. A device comprising:
a stand holding a tube, the stand defining an open space below the tube;
a screw conveyor disposed within the tube, including at least a handle at a first end connected to the screw conveyor; and
a first opening on the bottom of the tube to dispense material and a second opening on the top of the tube to accept material, the first opening closer to the handle than the second opening.

2. The device of claim 1 comprising a connection unit disposed on the stand to accept a removable container, the connection unit extending from the second opening.

3. The device of claim 2, wherein the connection unit comprises a first opening connected to the second opening of the tube and a second opening to connect to the removable container.

4. The device of claim 2, wherein the removable container comprises an opening.

5. The device of claim 2, wherein the removable container comprises a sealable cover.

6. The device of claim 3, wherein the opening of the removable container and the second opening of the connection unit have the same circumference.

7. The device of claim 1 wherein the screw conveyor rotates within the tube.

8. The device of claim 1, wherein the screw conveyor is turned by turning the handle.

9. The device of claim 2 comprising a sealing element connected to the connection unit.

10. A device comprising:
a tube having a first opening on a first side of the tube and a second opening on a second side of the tube, the tube holding a screw conveyor, one end of the tube including at least a handle connected to the screw conveyor;
a stand supporting the tube and having at least a base, and defining an open area above the base; and
a receptacle connected to the first opening, wherein the second opening empties into the open area.

11. The device of claim 10 comprising a container attached to the receptacle.

12. The device of claim 11 wherein the container is removably attached to the receptacle.

13. The device of claim 11, wherein the container comprises a base on a first side, and, and wherein the container comprises an opening on an opposite side, the opening to attach to the receptacle.

14. A device comprising:
a screw conveyor element accepting material from an upper container and dispensing the material to an open space located below the screw conveyor, the open space being defined by a stand supporting the screw conveyor.

15. The device of claim 14 comprising a container located above the screw conveyor and providing material to the screw conveyor.

16. The device of claim 14 wherein the container is removably attached to the screw conveyor.

17. The device of claim 14 comprising a sealing element connecting the container to the screw conveyor.
